(19) United States
(12) Patent Application Publication
(10) Pub. No.: US 2008/0162743 A1
(43) Pub. Date: Jul. 3, 2008

(54) METHOD AND APPARATUS TO SELECT AND MODIFY ELEMENTS OF VECTORS

(75) Inventor: Manfred Riener, Vienna (AT)

Correspondence Address: SCHNECK & SCHNECK, P.O. BOX 2-E, SAN JOSE, CA, 95109-0005, US

(73) Assignee: ON DEMAND MICROELECTRONICS, Vienna (AT)

(21) Appl. No.: 11/966,807

(22) Filed: Dec. 28, 2007

Related U.S. Application Data
(60) Provisional application No. 60/882,282, filed on Dec. 28, 2006.

(51) Int. Cl. G06F 3/00

(52) U.S. Cl. 710/30

(57) ABSTRACT

A method and apparatus to permute a given set of elements utilizing a permutation network which uses nodes and edges. The permutation network is a minimal network where each of the nodes except the input nodes has N+1 inputs and each of the nodes except the output nodes has N+1 outputs. Generation of any permutation of the provided input elements is allowed; permutations can even comprise copies of elements if desired. The network is characterized that for each output element at least two paths through the network to each input element exist and that each node can only process one element at a time.

### CROSS-REFERENCE TO RELATED APPLICATION

This application claims priority from U.S. Provisional Patent Application Ser. No. 60/882,282 entitled “Method and Apparatus to Select and Modify Elements of Vectors,” filed Dec. 28, 2006 and which is hereby incorporated by reference in its entirety.

### TECHNICAL FIELD

The invention relates generally to microprocessors and, in particular, to instructions to select and permute elements in vector processing operations.

### BACKGROUND

Applications of modern computer systems are requiring greater speed and data handling capabilities for uses in fields such as multimedia and scientific modeling. For example, multimedia systems are generally designed to perform video and audio data compression and decompression, and high-performance manipulation such as three-dimensional imaging. Massive data manipulation and an extraordinary amount of high-performance arithmetic, including vector-matrix operations, are also required for performing graphic image rendering.

High performance computation in modern processors often make use of the single instruction multiple data (SIMD) approach to process data in parallel. SIMD describes an architecture or a method where processing elements in a computational module are commanded from a single instruction stream to execute multiple data streams located one per processing element. Data, therefore, must be formatted as a vector. Some state-of-the-art processors provide a permute operation allowing flexible exchange of the vector elements. One example of an exchange of vector elements is described by Scales et al.

In U.S. Pat. No. 5,996,057 to Scales et al., entitled “Data Processing System and Method of Permutation with Replication within a Vector Register File,” a method is described to permute elements of two input vectors and to assemble an output vector from the permuted elements. Scales et al. is often cited in the art and describes an instruction of the AltiVec™ processor of Freescale Semiconductor, Inc. (based in Austin, Tex. USA). However, the AltiVec™ processor requires large multiplexers which increases an overall complexity of the system.

Other contemporary approaches provide only simple multiplexers that cannot deliver all possible combinations of input values. In U.S. Pat. No. 6,952,478 to Ruby et al., entitled “Method and System for Performing Permutations Using Permutation Instructions Based on Modified Omega and Flip Stages,” a permutation instruction is described that makes use of a omega flip network. The method and apparatus use predefined routes which can be switched with single bits of a control word. Copies of input values or simple conversion of data are not possible. Moreover, some embodiments cannot even deliver all combinations which do not include copied elements.

The computing performance required in multimedia applications, and especially in video decoding, is very high and needs flexible permutations. In addition, elements need to be copied, removed, or even expanded to higher bit widths. Moreover, the implementation has to be simple and of low complexity to save chip area and conserve power.

### SUMMARY

In various exemplary embodiments, a method and apparatus is disclosed herein to permute a given set of X elements, where X=2^{N} and N is an integer. The method and apparatus uses a permutation network utilizing nodes and edges. The permutation network is a minimal network where each node, except input nodes, has N+1 inputs and each node, except the output nodes, has N+1 outputs.

Moreover, a permutation network is disclosed comprising N stages where each stage defines a sub-network within the permutation network. All sub-networks can be identical. However, sub-networks according to the disclosure do not deliver a full set of permutations. Instead, a sub-network can be seen as a kind of cylinder that allows elements to rotate one step to the right, to the left, to keep its position, or even to another cylinder.

The disclosed method and apparatus allows generation of any permutation of the provided input elements whereas permutations can even comprise copies of elements if desired. The network may be characterized that for each output element at least two paths through the network to the input element exist and that each node can only process one element at a time.

An exemplary embodiment discloses an apparatus for permuting a set of X input elements and returning a set of X output elements. The apparatus comprises an input layer having a set of X input nodes, where X=2^{N} and N is an integer. Each of the set of X input nodes is configured to receive an element of the set of X input elements. A set of N−1 middle layers each has a set of X nodes with each of the set of X nodes having N+1 edges coupled to a previous layer and N+1 edges coupled to a subsequent layer. An output layer has a set of X output nodes with each of the set of X output nodes capable of returning one of the set of X input elements.

Another exemplary embodiment discloses a method of permuting a set of X input elements, where X=2^{N} and N is an integer. The method comprises loading the set of X input elements to an input layer having a set of X input nodes, receiving one of the set of X input elements at each of the set of X input nodes, forming N−1 middle layers with each of the N−1 middle layers having a set of X middle nodes, forming N+1 edges to a previous layer and N+1 edges to a subsequent layer on each of the set of X middle nodes, and outputting X output elements from an output layer.

Another exemplary embodiment discloses an apparatus for permuting a set of input elements and returning a set of output elements. The apparatus has a network comprising an input layer having an input means for receiving an element of the set of input elements, a set of N−1 middle layers each having a set of X nodes with each of the set of X nodes having N+1 edges coupled to a previous layer and N+1 edges coupled to a subsequent layer, and an output layer having an output means for returning one of the set of input elements.

### BRIEF DESCRIPTION OF THE DRAWINGS

The appended drawings illustrate exemplary embodiments of the present invention and must not be considered as limiting its scope.

FIG. 1A shows an exemplary permutation network with two input elements and two output elements.

FIG. 1B shows the permutation network of FIG. 1A where the input elements and the output elements are arranged in an Rx register an Ry register, respectively.

FIG. 2A shows an exemplary embodiment of a network consisting of two sub-networks 20-2 and 21. The sub-network 20-2 consists of two networks 20 which are shown in FIG. 1A.

FIG. 2B shows an exemplary embodiment of a network 31 obtainable by laying the networks 20-2 and 21 of FIG. 2A one atop the other. However, the network has different paths than the network shown in FIG. 2A.

FIG. 3A shows in simplified form an exemplary embodiment in which a network can be used as a single stage of a permutation network with four input and four output elements. Edges in the network are realized to allow passage of each element of the nodes 14 to the nodes 24 which are just below, next to the left, or next to the right.

FIG. 3B shows in simplified form an exemplary three-dimensional representation of the network shown in FIG. 3A in the form of a cylinder.

FIG. 4A shows in simplified form an exemplary embodiment of a network comprising two coupled networks 30 and allowing permutation of four input elements.

FIG. 4B shows in simplified form an exemplary three-dimensional representation of the network shown in FIG. 4A in the form of a cylinder.

FIG. 5A and FIG. 5B show two possible paths for the exemplary network of FIG. 4A to output a permutation “DCAB” when an input combination “ABCD” is applied.

FIGS. 6A-6C show three possible exemplary paths for the network of FIG. 4A to output the permutation “ACDB” when the input combination “ABCD” is applied.

FIG. 7A shows exemplary paths for the network of FIG. 4A to output the permutation “AABA” when the input combination “ABCD” is applied. The output permutation in this example contains copies of A.

FIG. 7B shows exemplary paths for the network of FIG. 4A to output the permutation “ACBB” when the input combination “ABCD” is applied. The output permutation in this example contains copies of A.

FIG. 8 shows an exemplary invalid permutation network. FIG. 8 is the network of FIG. 4A where the left upper vertical edge has been removed and demonstrates that the network of FIG. 4A is minimal because it cannot create all permutations. The permutation “CADA” cannot be generated with the invalid permutation network of FIG. 8. The left upper vertical line which has been removed to generate the network FIG. 8 which can otherwise be considered as equal to the other edges of FIG. 4A.

FIG. 9 shows in simplified form an exemplary embodiment of a permutation network comprising two coupled networks 31 and allowing permutation of four input elements. The network is functionally similar to the network of FIG. 4A, however, with different paths.

FIG. 10A shows another exemplary embodiment which is an implementation of a stage that handles eight elements. The network comprises a network 30-2 which consists of two stages 30 according to FIG. 3A and a network 22.

FIG. 10B shows an exemplary embodiment of a network 40 obtainable by laying the networks 30-2 and 22 (which are shown in FIG. 10A) on atop the other. However, the network has different paths than the network shown in FIG. 10A.

FIG. 11 shows an exemplary embodiment of a permutation network with eight input elements 18 and eight output element 58.

FIG. 12 shows an exemplary embodiment of a permutation network with four input elements and two output elements.

FIG. 13 shows an exemplary embodiment of a permutation network with two input elements and four output elements.

FIG. 14 shows an exemplary embodiment implementing the network of FIG. 4A using multiplexers 105 and 107 to select appropriate paths.

FIG. 15 shows another exemplary embodiment of a permutation network similar to the permutation network of FIG. 4A. However, output elements are forwarded to processing units 121, 122, 123, and 124 thus allowing further processing.

### DETAILED DESCRIPTION

In mathematics, a permutation is defined as an arrangement of input elements into distinguishable orderings. Each unique ordering is called a permutation. That is, a number of X input elements results in X! different permutations, where X! is the factorial of X (i.e., X!=[X·(X-1)- . . . - 2]) and where each permutation has X elements.

However, as described herein, the orderings may include copies of elements as well whereas other elements can be excluded. Therefore, a permutation is defined as an arrangement- of X given input elements into distinguishable combinations of Y output elements where each output element can be any of the X input elements. Each unique combination is thus termed a permutation as used herein. In other words, X input elements define a set of X symbols and an output is a combination of Y symbols. Therefore, X^{Y} (X to the power of Y) combinations (i.e., permutations) exist.

For example, the three input elements A, B, and C (in short “ABC”) can result in the following combinations—herein termed permutations—with three digits: “AAA,” “AAB,” “AAC,” “ABA,”, “ABB,” “ABC,” “ACB,” “ACC,” “BAA,” “BAB,” “BAC,” “BBA,” BBB, “BBC,” “BCA,” “BCB,” “BCC,” “CAA,” “CAB,” “CAC,” “CBA,” “CBB,” “CBC,” “CCA,” “CCB,” and “CCC.” Thus, three inputs with three outputs results in 3³=27 permutations.

Another example is an input “ABC” (three input elements A, B, and C) can have the following permutations with two digits: “AA,” “AB,” “AC,” “BA,” “BB,” “BC,” “CA,” “CB,” and “CC.” Thus, three inputs with two outputs results in 3²=9 permutations.

Another example is the input “AB” (two input elements A and B) which can have the following permutations with three digits: “AAA,” “AAB,” “ABA,” “ABB,” “BAB,” “BBA,” and “BBB.” Thus, two inputs with three outputs results in 2³=8 permutations.

In the following disclosure, a novel method and apparatus to generate any permutation of input elements is disclosed. The disclosed method and apparatus is not limited to which combination or sets of the input elements are provided. In some embodiments, the X input elements can be provided separately. In other embodiments, the X input elements can be provided in one or more input vectors, where each vector has a certain number of input elements. Other embodiments may combine the X output elements in one or more output vectors. The vectors, for example, can be read from registers, memories, or can be provided from other modules.

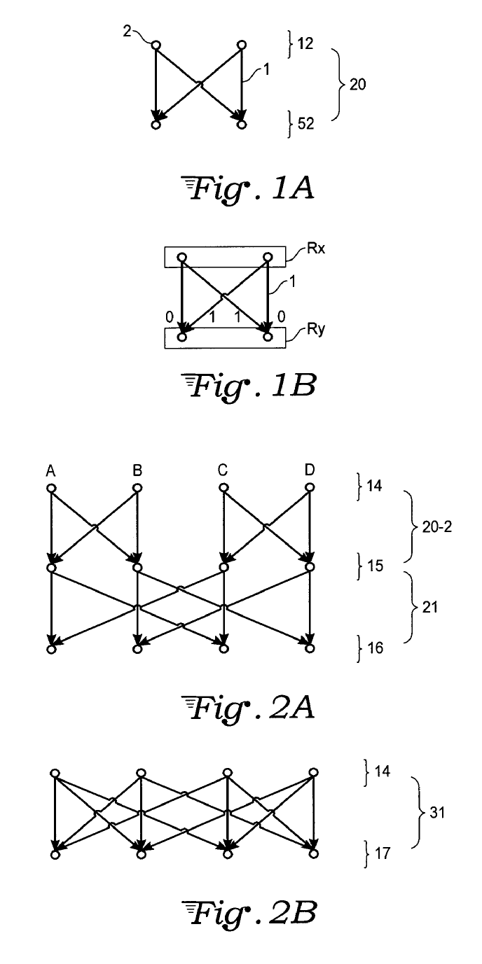

FIG. 1A shows a network 20 for permutation. A network comprises nodes and edges. Values (elements) in a network flow from one node to another node through edges. Nodes in a network can be arranged in layers. Nodes of a layer have no connections between nodes of the same layer and only have connections to a previous and a next layer. The network 20 shown in FIG. 1A allows permutation of two input elements to two output elements. The network 20 has two nodes 12 which define a first layer of nodes and two nodes 52 which define a second layer of nodes. The nodes 12 of the first layer represent the two input elements. The nodes 52 of the second layer represent the two output elements. Edges 1 define possible transitions in the network for the input elements 12 to the output elements 52. The arrows in the network 20 denote a direction in which elements can be forwarded to other nodes. The network 20 thus allows all combinations of output elements as each input element has a path to each output element.

Nodes which receive elements (e.g., the nodes 52 in FIG. 1A) can be multiplexers, OR-gates, or any other switching or logical elements known in the art. Nodes which forward elements (e.g., the nodes 12 in FIG. 1A) can be demultiplexers, memories, or any other logical element.

FIG. 1B shows the same network 20 (FIG. 1A) where input elements and output elements are stored in registers Rx and Ry, respectively. Each element of Ry has two paths which are denoted with 0 and 1. In this example, 0 denotes that an element in Ry has to be loaded directly from the corresponding element in Rx at the same position. A value of 1 indicates that the element in Ry has to be loaded from the other position of Rx.

FIG. 2A shows a network which consists of two sub-networks 20-2 and 21. The sub-network 20-2 itself consists of two networks 20 (which is shown in FIG. 1A). In the example of FIG. 2A, a plurality of first nodes 14 receive a combination of elements “ABCD” (the four elements A, B, C, and D). The networks 20-2 and 21 allow transitions as shown in FIG. 2A. Each node can handle only one element at a time. According to the edges within 20-2, the left two nodes 15 can result to “AA,” “AB,” “BA,” or “BB” and the right two nodes can be “CC,” “CD,” “DC,” or “DD.” These combinations in the second nodes 15 can be forwarded to a set of third nodes 16. As indicated, each of the input elements of the first nodes 14 has a path to each of the third nodes 16. Elements can be duplicated as well. For instance, to receive the combination “AAAA” in the third nodes 16, the network 20-2 may be switched in a way that the second nodes 15 hold “AACD” and the subsequent network 21 then is switched to receive “AAAA” in the third nodes 16. However, the network shown in FIG. 2A does not allow all combinations for the output. For example, the combinations “AABB,” “BBAA,” “CCDD,” or “DDCC” are not possible.

With reference to FIG. 2B, a network 31 can be obtained if one lays the networks 20-2 and 21 (which are shown in FIG. 2A) on top of each other. However, the network 31 different paths from the network shown in FIG. 2A. For instance, the network of FIG. 2A allows “DCBA” but not “AACB” for the third nodes 16. In contrast, the network of FIG. 2B allows “AACB” but not “DCBA” for the nodes 17.

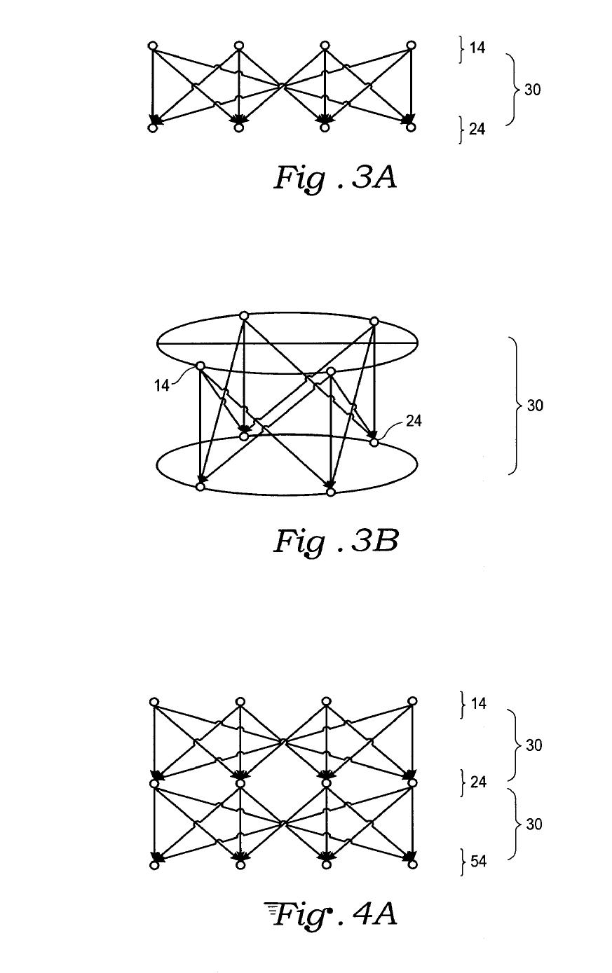

However, to outline advantages of the network 31 shown in FIG. 2B, the edges are changed to the network 30 of FIG. 3A (the columns of the network FIG. 2B are exchanged). The edges of FIG. 3A are realized in a way to pass each element of the first nodes 14 to the second nodes 24 which are Just below, next to the left, or next to the right. The leftmost and rightmost nodes of the first nodes 14 are connected to the rightmost or leftmost of the second nodes 24, respectively.

FIG. 3B shows the same network in the form of a three-dimensionally cylinder. The network 30 allows each element to hold its position in the cylinder, to be rotated one to the left, and/or to be rotated one to the right. Characteristic of the network diagrams described herein, each node can handle or hold only one element at a time. That is, it is not possible for one node to, for example, receive two elements, exchange them, and forward them both. However, the network 30 of FIG. 3B has similar disadvantages of the networks of FIGS. 2A or 2B: not all permutations are possible. For instance, if a combination of “ABCD” is applied as an input, the combination “CDAB” is not possible.

A stage is defined herein as a network which connects two adjacent layers. The nodes of the adjacent layers can be seen to be part of the layers or not.

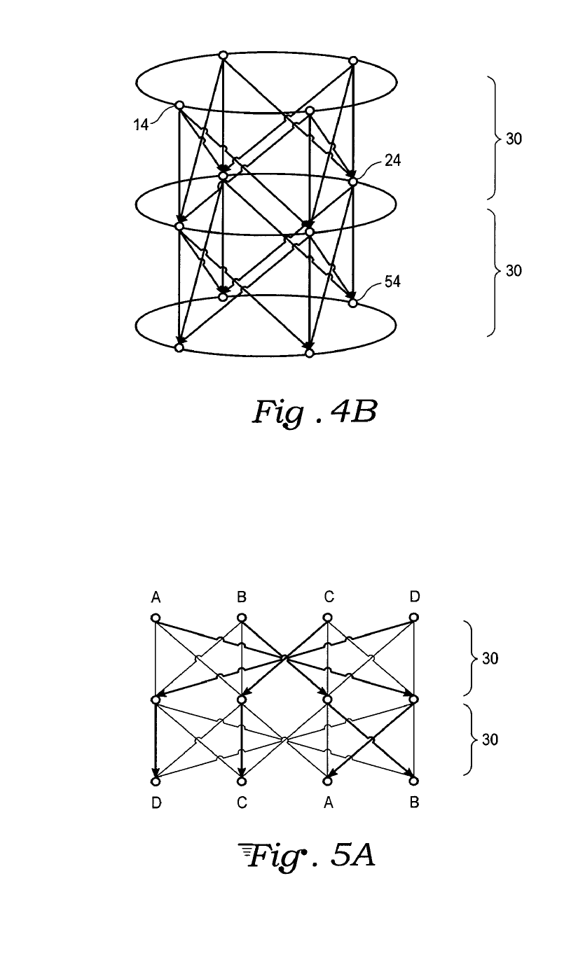

With reference to FIG. 4A, the network shown is comprised of two coupled networks 30. The network has four input elements and two stages (i.e., the two coupled networks 30). The first and the second stage—the sub-networks 30—each allow an element to “rotate” one position to the right or one position to the left. Therefore, each position in the network can be reached. That is, for each input node 14, a path to an output node exists.

To be precise, the network of FIG. 4A allows several paths: each node except the input nodes 14 has three connections to nodes of the previous layer. That is, three arrows go to these nodes. Moreover, each node except the output nodes 54 has three connections to nodes of the next layer; i.e., three arrows leave these nodes. The network of FIG. 4A thus allows all possible permutations. For each permutation at least one path exists.

For a better understanding of the plurality of paths described above, FIG. 4B shows the same network in three dimensions. Both the first and the second stage allow each element to maximally rotate one step to the left or one step to the right.

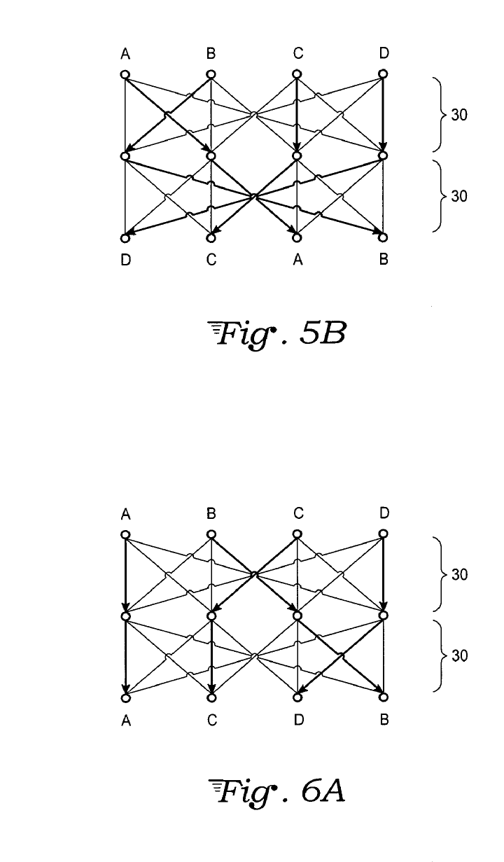

FIGS. 5A and 5B show two examples for the network explained in FIG. 4A. The input combination “ABCD” is applied and both networks in the FIGS. 5A and 5B give the permutation “DCAB.” The examples in FIGS. 5A and 5B demonstrate that the network of FIG. 4 can be configured (or switched) in at least two different ways to deliver any output combination.

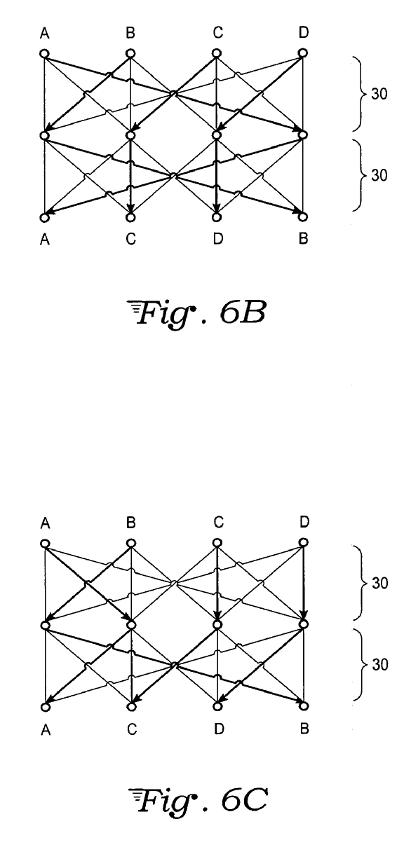

FIGS. 6A-6C show three examples for the network explained in FIG. 4A. The input combination “ABCD” is applied to the networks of FIGS. 6A-6C and delivers the permutation “ADCB.” The examples in FIGS. 6A-6C demonstrate that the network of FIG. 4A can be configured in three different ways to deliver certain output combinations.

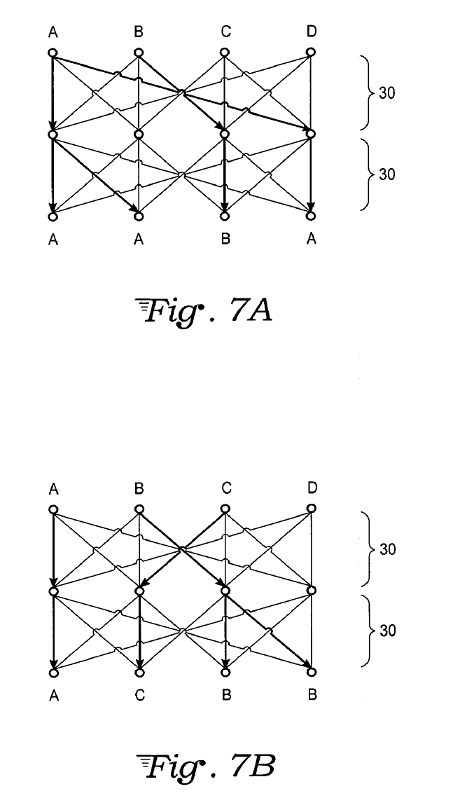

FIG. 7A shows an example of the permutation network of FIG. 4A which delivers a permutation “AABA” and which contains copies of the element “A.” FIG. 7B shows an example of the permutation network FIG. 4A which delivers a permutation “ACBB” that contains copies of the element “B.” One can see that each node handles at most one element.

One can easily see that in the network shown FIG. 4 three paths exist for each node 14 to a node 54 which is directly below that certain node 14. Moreover two paths exist for each node 14 to all other nodes 54 which are not directly below the certain node 14.

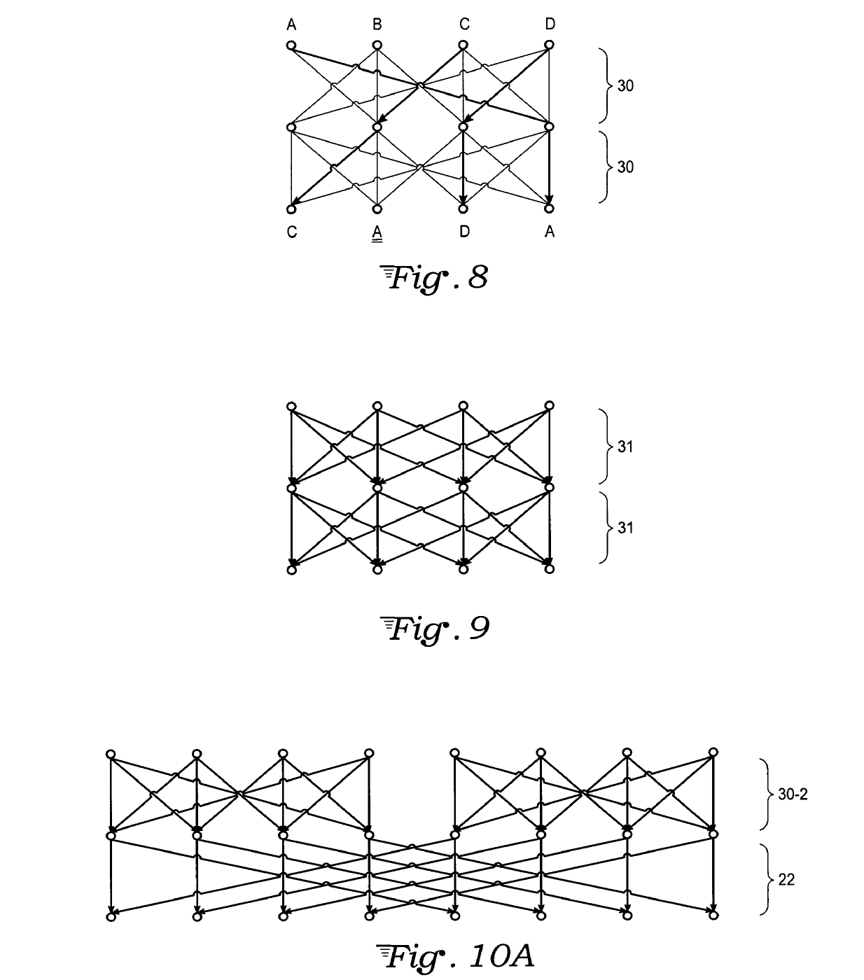

However it is not possible to remove one of the edges of the network shown FIG. 4A. This is explained by means of the example shown in FIG. 8. Imagine, for example, the vertical upper left edge in FIG. 4A is removed (see FIG. 8). In that case, the permutation “CADA” could not be obtained. The bold arrows denote connections which can be built. Because of the missing edge, the rightmost position for “A” can only be obtained with one path as outlined. The element “D” left beside can then only be achieved as shown. “C” now only can be routed using the path as outlined. There is no path left to route the second “A” to the position “A.”

However, as all edges in the network of FIG. 4A can be considered as equal, the example of FIG. 8 demonstrates that the network provided in FIG. 4A is a minimal network that allows generation of all possible permutations of the input elements “ABCD” (where copies are allowed as discussed above).

FIG. 9 shows another embodiment which is a permutation network utilizing two coupled stages 31 as shown in FIG. 2B. The network of FIG. 9 is similar to the network given in FIG. 4A allowing the same number of paths from an input element to an output element. Each node has the same number of input connections and output connections. However, the connections (the edges) are different than in FIG. 4A. Therefore, the network of FIG. 9 has different paths and can require different configurations to switch the circuit.

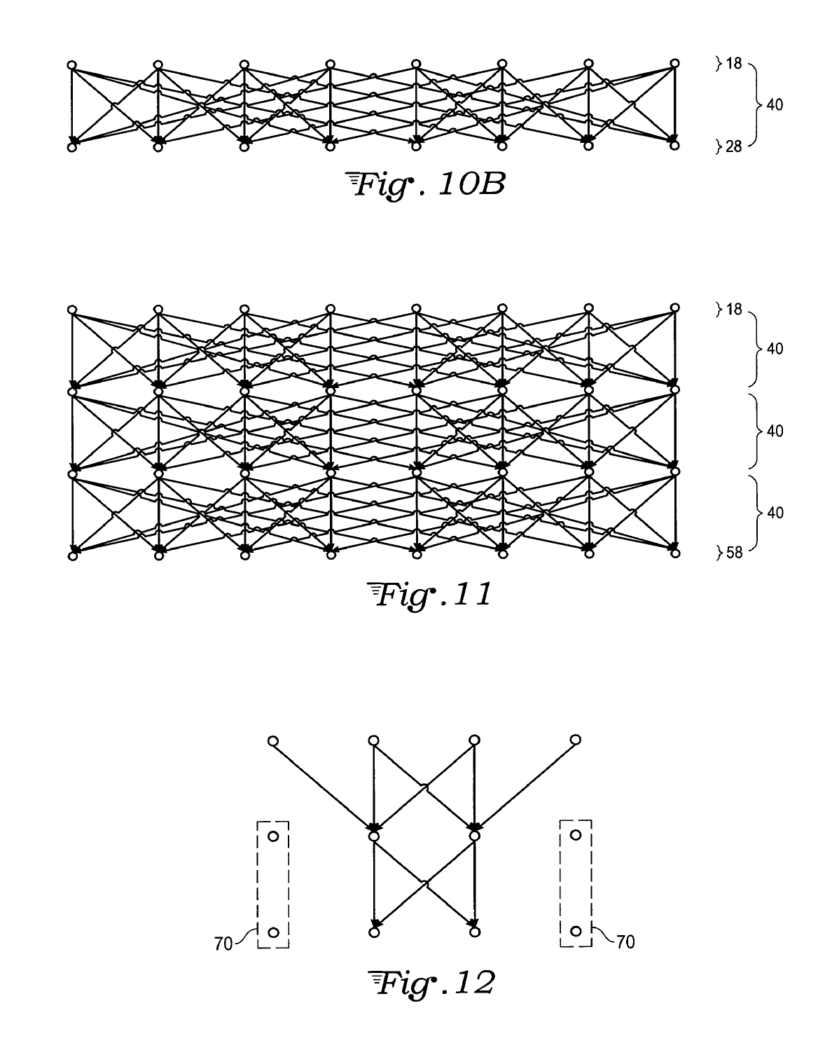

Another embodiment shown in FIG. 10A is an implementation of a stage that handles eight elements. The network of FIG. 10A comprises a network 30-2 which consists of two stages 30 according to FIG. 3A. As discussed above, each network 30 can be seen as a stage of a cylinder allowing a rotation of elements. Hence, the network of FIG. 10A can be seen as a single stage of a network that has two single-stage cylinders. The subsequent sub-network 22 allows an interconnection to the other cylinder.

If both sub-networks 30-2 and 22 are put on top of one another, a single stage of a permutation network is generated. Such a single stage 40 of a permutation network that allows a permutation of eight elements as shown in FIG. 10B. The networks of FIGS. 10A and 10B each have different paths through the network.

FIG. 11 shows a permutation network with eight input elements 18 and eight output element 58. The network of FIG. 11 again allows several paths from one of the input elements 18 to one of the output elements 58. Each node, except the input nodes 18, has four connections to nodes of the previous layer; i.e., four arrows go to these nodes. Moreover, each node, except the output nodes 58, has four connections to nodes of the next layer, i.e., four arrows leave these nodes. The network of FIG. 4A allows all possible permutations. For each permutation at least one routing scheme exists.

In general, embodiments of the present disclosure describe a permutation network with 2^{N} input elements, 2^{N} output elements and N stages. Each node except the input nodes has (N+1) connections to nodes of the previous layers. Each node except the output nodes has (N+1) connections to the next layer. The resulting network allows all permutations of the 2^{N} input elements.

FIG. 12 shows an exemplary permutation network with four input elements and two output elements. The network corresponds to the network shown in FIG. 4A with unnecessary nodes removed. All edges which connect omitted nodes 70 removed. The network shown in FIG. 12 allows all permutations of the four input elements into the two output elements.

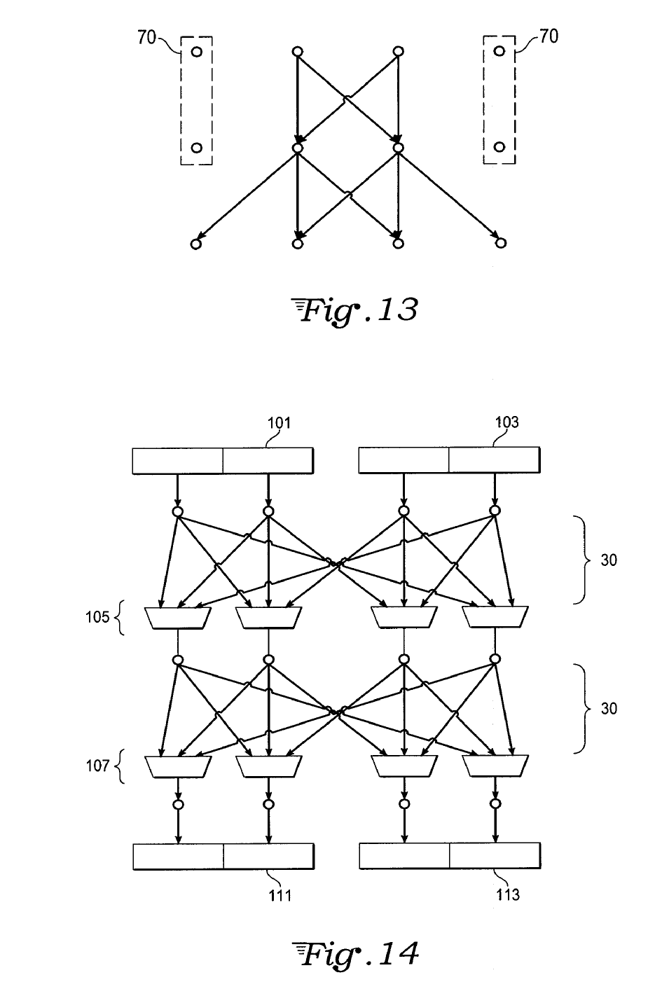

FIG. 13 shows an exemplary permutation network with two input elements and four output elements. The network corresponds to the network shown in FIG. 4A with unnecessary nodes removed. All edges which connect omitted nodes 70 removed. The network of FIG. 13 allows all permutations of the two input elements in the four output elements.

Advantages of the system and method described herein include utilizing a minimal interconnection network. Typical implementations of the prior art use multiplexers that have 2^{M} inputs at each node. In contrast, implementations of embodiments described herein utilize only (M+1) inputs at each node. Each node is an input to only (M+1) succeeding nodes. Moreover, all possible permutations including copies of elements can be generated.

FIG. 14 shows a specific exemplary embodiment utilizing a first 105 and a second 107 set of multiplexers to select a path in a node. In this specific embodiment, the four input elements are arranged in a first 101 and a second 103 set of registers where each register comprises two elements. Moreover output elements are stored in a first output register 111 and a second output register 113. The circuit shown in FIG. 14 is an implementation of the method shown in FIG. 4A and uses an interconnection mechanism 30 to provide the input elements for the first 105 and second 107 sets of multiplexers. Depending on control signals provided to the first 105 and second 107 sets of multiplexers, a permutation of the input elements is stored in the first output register 111 and the second output register 113.

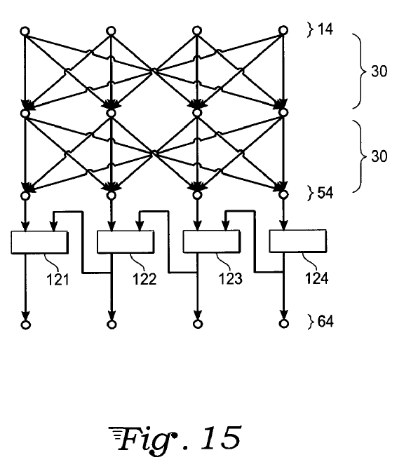

As an extension to the method of permutation described above, FIG. 15 shows another specific exemplary embodiment. The permutation network of FIG. 15 is equivalent to the permutation network of FIG. 4A. However, the output elements 54 are forwarded to a set of processing units 121, 122, 123, 124. The set of processing units 121, 122, 123, 124 are controlled by an external unit (not shown) and can, for example, be used to perform a sign extension.

In a signed digital value, the most significant bit can be used to indicate whether the value is interpreted as a positive or a negative number. A sign extension is defined as an extension of the digital value to a higher number of bits where the most significant value is copied to the preceded bits that have been added.

The circuit in the specific exemplary embodiment of FIG. 15 can then be controlled such that the rightmost value of the nodes 54 is copied to the rightmost value of an output value 64 which is sign extended by the third processing unit 123 in the output value 64 next to the left of it. Other embodiments of the present disclosure can replace (or set values to zero) the input values 54 using the processing units 121, 122, 123, 124 or even can perform calculations on the elements such as to calculate an absolute value. Such embodiments use the processing units 121, 122, 123, 124 to modify the permuted elements of the input values 54 and forward the modified elements of the output value 64 to subsequent stages. An advantage of such a circuit is, that from a combination of input elements, arbitrary elements can be selected, modified, and forwarded to subsequent modules for further processing. These operations may be performed within a single clock cycle thus allowing for fast processing.

The present invention is described above with reference to specific embodiments thereof. It will, however, be evident to a skilled artisan that various modifications and changes can be made thereto without departing from the broader spirit and scope of the present invention as set forth in the appended claims. For example, particular embodiments describe a number of processing units and logical elements per stage. A skilled artisan will recognize that these numbers and particular elements are flexible and the quantities and types shown herein are for exemplary purposes only. Additionally, a skilled artisan will recognize that various numbers of stages may be employed for various applications. Also, various embodiments may be implemented by hardware, firmware, or software elements, or combinations thereof, as would be recognized by a skilled artisan. These and various other embodiments are all within a scope of the present invention. The specification and drawings are, accordingly, to be regarded in an illustrative rather than a restrictive sense.

What is claimed is:

1. An apparatus for permuting a set of X input elements and returning a set of X output elements, the apparatus comprising:
an input layer having a set of X input nodes, where X=2^{N} and N is an integer, each of the set of X input nodes being configured to receive an element of the set of X input elements;
a set of N−1 middle layers each having a set of X nodes, each of the set of X nodes having N+1 edges coupled to a previous layer and N+1 edges coupled to a subsequent layer; and
an output layer having a set of X output nodes, each of the set of X output nodes capable of returning one of the set of X input elements.

2. The apparatus of claim 1 wherein each node of the output layer is coupled to a path through the apparatus to one of the set of X input nodes and each of the edges is a connection between a start node and an end node.

3. The apparatus of claim 1 wherein N is at least 2.

4. The apparatus of claim 1 wherein each of the N+1 edges is configured to transfer one of the set of X input elements from a start node to an end node.

5. The apparatus of claim 1 wherein each of the nodes can accommodate only one of the set of X input elements at a time.

6. The apparatus of claim 1 wherein each node except nodes coupled to the input layer has N+1 inputs which are connected to nodes of a previous stage.

7. The apparatus of claim 1 wherein each node except nodes coupled to the output layer has N+1 outputs which are connected to nodes of a subsequent stage.

8. The apparatus of claim 1 further comprising at least two paths to each node of the input layer for each node of the output layer.

9. The apparatus of claim 1 further comprising a set of processors configured to perform operations on output elements.

10. A method of permuting a set of X input elements, where X=2^{N} and N is an integer, the method comprising:
loading the set of X input elements to an input layer having a set of X input nodes;
receiving one of the set of X input elements at each of the set of X input nodes;
forming N−1 middle layers with each of the N−1 middle layers having a set of X middle nodes;
forming N+1 edges to a previous layer and N+1 edges to a subsequent layer on each of the set of X middle nodes; and
outputting X output elements from an output layer.

11. The method of claim 10 further comprising selecting the output layer to have a set of X output nodes each returning an element according to a path through the network.

12. The method of claim 11 further comprising forming a path from each of the set of X output nodes to one of the nodes of the set of X input nodes.

13. The method of claim 10 further comprising selecting each node of the output layer to have N+1 edges to nodes of one of the N−1 middle layers.

14. The method of claim 10 further comprising selecting N to be at least 2.

15. The method of claim 10 further comprising allowing each edge to transfer one of the set of X input elements from a start node of each edge to an end node of each edge.

16. The method of claim 10 further comprising allowing each of the nodes to accommodate only one element at a time.

17. The method of claim 10 further comprising selecting each node except the nodes of the input layer to have N+1 inputs which are connected to nodes of a previous stage.

18. The method of claim 10 further comprising selecting each node except the nodes of the output layer to have N+1 inputs which are connected to nodes of a subsequent stage.

19. The method of claim 10 further comprising selecting at least two paths to each node of the input layer for each node of the output layer.

20. The method of claim 10 further comprising performing operations on the X output elements, the operations being a selected from the group consisting of a sign extension, inverting, and an absolute value.

21. An apparatus for permuting a set of input elements and returning a set of output elements, the apparatus having a network comprising:
an input layer having an input means for receiving an element of the set of input elements;
a set of N−1 middle layers each having a set of 2^{N} nodes, each of the set of 2^{N} nodes having N+1 edges coupled to a previous layer and N+1 edges coupled to a subsequent layer; and
an output layer having an output means for returning one of the set of input elements.

22. The apparatus of claim 21 further comprising a processing means for performing operations on output elements.
